(19) United States
(12) Patent Application Publication
(10) Pub. No.: US 2005/0072348 A1
(43) Pub. Date: Apr. 7, 2005

(54) Insta-check

(76) Inventor: Brian Domonic Johns, Celina, OH (US)

Correspondence Address: BRIAN D. JOHNS, 7881 RT 33, CELINA, OH, 45822, US

(21) Appl. No.: 10/797,288

(22) Filed: Mar. 10, 2004

Related U.S. Application Data
(60) Provisional application No. 60/453,873, filed on Mar. 11, 2003.
(60) Provisional application No. 60/460,694, filed on Apr. 4, 2003.
(60) Provisional application No. 60/531,734, filed on Dec. 8, 2003.

(51) Int. Cl. G01M 17/02

(52) U.S. Cl. 116/34 B; 73/146; 340/442

(57) ABSTRACT

This Invention Is claimed on a Tire Gauge That Fits and Screws onto the Valve Stem to Monitor Your Tire Pressure manually or By Radio Wave Frequency.

This is a tire pressure monitoring system that fits on existing or new valve stems.

Basic use is for any entity's that are inflated by means of air.

Examples being motor vehicle tires. Both manual and radio frequency tire monitoring apply in this application.

The inventors name is BRIAN D. JOHNS located at 7881 State Route 33 Celina, Ohio 45822, United States Of America

### FIELD OF INVENTION

This invention pertains to a manual and radio frequency tire gauge that will remain on the valve stem or the tire of your vehicle at all times to monitor your air tire pressure.

The radio frequency gauge will be monitored from inside and outside the vehicle and is able to be let on valve stem when inserting air.

The manual tire gauge will only monitor at the tires valve stem.

### CROSS-REFERENCE TO RELATED APPLICATIONS

NA

### FEDERALLY SPONSORED RESEARCH

NA

### COMPACT DISK APPENDIX

NA

### FIELD OF INVENTION

This invention pertains to a tire gauge that is placed on your valve stem and remains there at all times.

The invention called (INSTA-CHECK) can be monitored inside or outside your vehicle this device can also be removed if needed.

### DETAILED DESCRIPTION OF INVENTION

FIG.#1 is a manual tire pressure monitoring gauge that you fit on you valve stem.

FIG.#1 Requires FIG.#4 Screw on nipple receiver Assistant by screwing FIG.#4 onto your tire valve stem and FIG.#4 will not be required if the bottom of FIG.# 1 is replaced with conventional threading that allows FIG.#1 to be screwed directly to your tire valve stem.

FIG.#1 has a Gauge stick that when pushed towards valve stem by item 5, the stair step rim will cause item 4, air pressure stick to pop outward and show actual tire pressure.

Ref. # 4 will show pressure of tire up to 10 pounds over or under the line indicator or marks showing how much pressure is in the tire per ref. # 4, air pressure stick.

This FIG.#1 stays on your valve stem at all times or until air pressure is needed and can easily removed and put back on the valve stem to recheck air tire pressure as many times as needed.

FIG.#1 ref. # 9, Insert spring is used at half compressed tension all the time when staying on the air valve stem.

Item 10, FIG.#1 is the inverted nipple receiver per Ref. # 10 that pushes down over FIG. #4 when FIG. # 4, screw on nipple receiver is in place.

When ref. 9, Insert spring if fully compressed to ref. 8, pressure valve air is released into ref. 6, main air chamber by compressing ref. # 7, tension spring and internal air pushes ref. # 4, air pressure stick outward.

Ref. # 4 also has 2, air pressure spring that monitors pressure outward.

Ref. #2 air pressure spring is designed and engineered for proper tire pressure.

FIG. #1 CALLED INSTA-CHECK CAP is a cap designed to go on top FIG. #1 manual tire pressure gauge called INSTA-CHECK.

FIG.#1A has ref. #9,insert spring that when installed on FIG.#1 will stay in place by ref. # 10 inverted nipple receiver connected to ref. #1, nipple receiver of FIG.#1 until removed for quick and easy removal.

FIG. #2 a manual tire pressure monitoring gauge is similar to FIG. #1 except that FIG. #2 screws on the valve stem per ref. #17, treaded invert.

FIG. #2 will slide up and in REF. # 10. Inverted nipple area with ref. #17, treaded Invert having ref. #1 nipple receivers on one or both sides made with to it to slide up and down.

FIG. #2, is a manual tire pressure monitoring gauge; ref. #17, treaded Invert has ref. # 7, tension spring placed behind it to hold it back from ref. #17 from hitting ref. #8, pressure valve until FIG. #2 is pushed down toward valve stem that will compress ref. #7, tension spring and will decompress the spring when released.

FIG. #2, manual tire pressure monitoring gauge in reference to ref. # 16 inverted nipple receiver chamber will hold down item#7 tension spring until it is released manually.

FIG.#3 a manual tire pressure monitoring gauge is exactly the same as FIG.#2 a manual tire pressure monitoring gauge except ref. #2 air pressure spring has been added and a top threaded head has been placed on FIG.#3 which means two engineered air pressure springs are placed within FIG. #3.

The additional spring attaches to the backside of ref. #8 pressure valve. Then attaches to the bottom side of ref. # 4 air pressure stick.

FIG. #4 is a screw on nipple receiver that screws on existing on new valve stems to be used with FIG. #1 and FIG. #5.

FIG. #5 is Radio Frequency Tire Pressure Monitoring System that can be controlled by radio frequency per ref. #19, digital control box and controls ref. #38 heat and pressure sensor.

FIG. #5 Radio Frequency Tire Pressure Monitoring System has a square screw a cap ref. #25 along with ref. #23 easy changing round battery.

FIG. #5 Radio Frequency Tire Pressure Monitoring System has a display screen ref. #20, for showing pressure and temperature of tire at the unit as well as inside the vehicle.

FIG.#5 can also be done manually without radio frequency involved if ref. #20 Display screen is remaining.

FIG. #5 Radio frequency Tire Pressure Monitoring System Has a Item#9 insert spring and item#10 inverted nipple receiver to be used with FIG. #4 screw on nipple receiver.

FIG. #5 radio frequency tire pressure monitoring systems per Ref. #9 and #10 can also be replaced with ref. #17 as a treaded invert that will screw directly to the valve stem.

FIG. #6 Valve Stem Adapter can be used to extend your valve stem to receive FIG. #1A INSTA-CHECK CAP.

FIG. #6 will screw onto the valve stem and stay there and the insta-check cap can quickly be removed on or off conditions as well as FIGS. #1 and #5 can be used on this adapter.

FIG. #7 will be monitored by radio wave requency sent from ref. #34 and heat/pressure sensor ref. #38 to a receiver located inside your vehicle and monitored within the vehicles dashboard that any consumer can purchase.

FIG. #7 may be purchased separately from the receiver unit that each FIG. #7 to be programmed to work within all vehicles that obtain the receiver unit.

FIG. #7 the size and length of the figure would be determined by air pressure requirements.

FIG. #7 stays on your tire at all times and is fed air from the exposed top end until desired pressure is met without having to remove FIG. #7 from the valve stem.

Per FIG.#7, Air is then dispursed down the shaft into ref.#39 four dividing air chambers that the air reaches to ref.# 38 heat/pressure sensor and dispersed through the valve stem into the tire.

Reference#20 digital display screen will show air pressure within tire after you have completed termination of air supply.

Ref. #20 is not required for FIG. #7 and can be omitted if desired.

FIG. #7 an alarm can be placed witin the receiver to let you know when you meet the desired pressure by beeping sounds.

FIG. #7 can be designed to have solar panels within ref. #47 hollow cavity

FIG. #7 a round battery to be placed within lid cover and snaps into grooves of ref. # 42 which makes contact with ref.#41 battery connector then is then sent from ref. #42 to ref. #34 radio control chip then to ref.#20 a digital display board.

Ref. #41,42,34 and 20 are connected through ref. #35 a round wire connector chase then signaled to ref. # 38 a heat/pressure sensor to Ref.#34 then sends a signal to the receiver located within the vehicle.

The body frame of all figures listed ref.#14,27,32 and 37 can be made of plastic or aluminum or lightweight base metal's and the insides of all objects ref.# 2,7,8, and #9 can be made of can be made of copper or aluminum or lightweight base metal's.

Refrerence Index

1. Nipple Receiver.
2. Air Pressure Spring.
3. Non Pressure Air Cavity.
4. Air Pressure Stick.
5. Stair Step Rim Design with Recess Area for Finger Grip.
6. Main Air Pressure Chamber.
7. Tension Spring for Main Pressure valve.
8. Pressure valve.
9. Insert Spring to Hold down Entire Gauge on Valve Stem.
10. Inverted nipple receiver.
11. Open End Of Valve Stem. Use New Cover Cap For On/Off Applications.
12. Cover Cap Design To Fit Over Top End Of FIG. #1.
13. NA.
14. This is the main body pressure gauge checker that is removable from valve stem if needed.
15. Recessed Area For Finger Griping.
16. Inverted Nipple Receiver Chamber This Area Is To Hold Down Pressure Gauge Temporarily Until You Are Ready To Release It or Until You Can Read The Gauge.
17. Used with FIG. #2 as a threaded invert that will fit over the valve stem threads and will slide within the body shaft of Ref.# 14 until it hits #8 valve stem that will release pressure To #4 air pressure stick.
18. Access Area to Receive Air Pressure Reading to Digital Control Box Ref. #19.
19. Digital Control Box for Reading Tire Pressure and Temperature.
20. Digital Monitor Screen to Read Temperature and Pressure of Tire.
21. Protective Clear Plastic Cover. To Protect Ref. #20.
22. Metal Connector to Connect Battery to Digital Control Box Ref. #19 Battery.
23. Battery.
24. Threaded Receiver To Receive Ref. #25 Plastic Threaded Body Cap.
25. Threaded Body Cap To Screw Into Ref. #24.
26. Top of Cap for Ref. #25 with Non Slip Surface.
27. Body of FIG. #5.
28. Copper Body of FIG. #4.
29. Adhered rubber for gripping of threads when screwed on valve stem.
30. NA
31. Threaded Receiver To Fit And Screw Onto All Valve Stems.
32. Body of FIG. #6.
33. Threaded Nipple Receiver for Standard Industry Caps.
34. Radio Control Chip Sandwiched between A Plastic Cover.
35. Wire Connector Chase to Connect Battery to Ref. #34, 19, 20 and 38.
36. Protective Plastic Cover That Protects Ref. #34 and is Designed within a four Way Air Chamber.
37. Body Frame of FIG. #7.
38. Heat/Pressure Sensor.
39. Four Way Air Pressure Divider Chamber.
40. Cradle Area to Hold Battery in Place.
41. Metal Battery Connector.
42. Edge Slide Slots for Battery Cover to Slide Into.
43. Stop Lip Edge To Stop Battery Cover To Its Final Resting Place.
44. Embossed Finger Grip Surface to remove battery Cap Easily.
45. Battery Cover.
46. NA.
47. Hollow Cavities. Can Be Design To Encase Solar Panels for Longer Lasting Batteries.

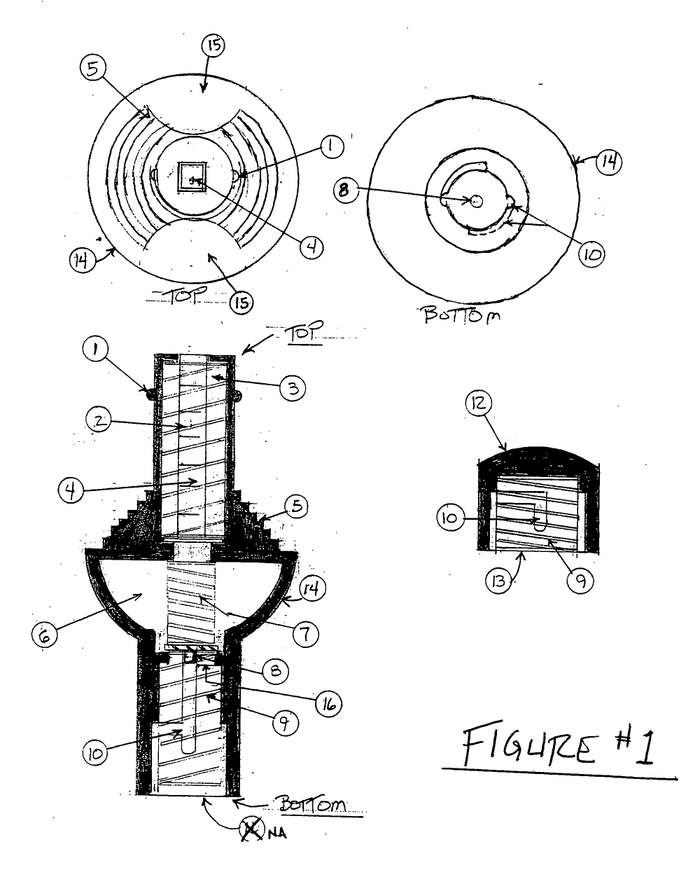

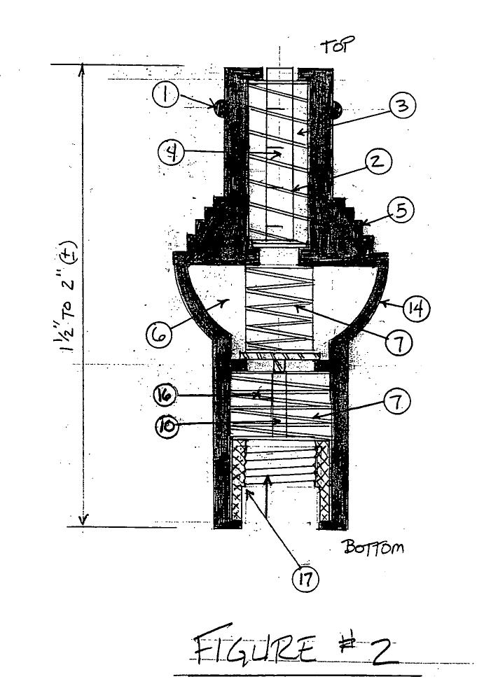

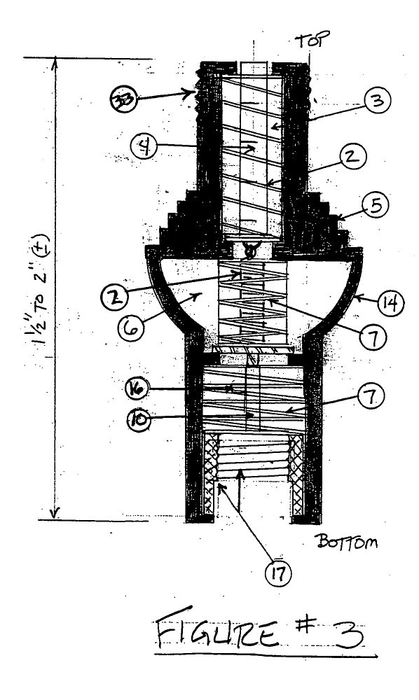

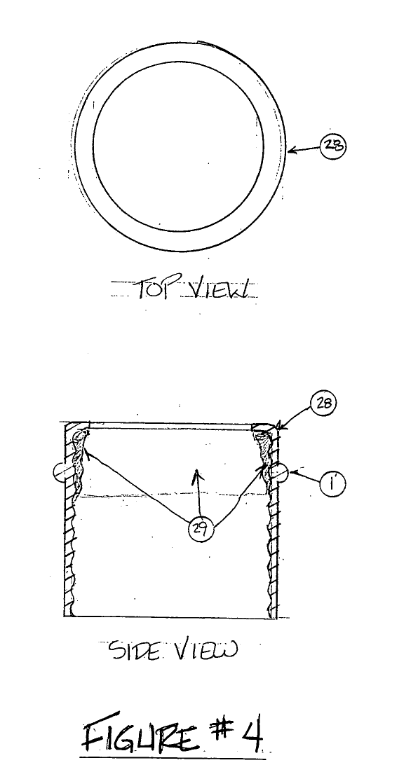

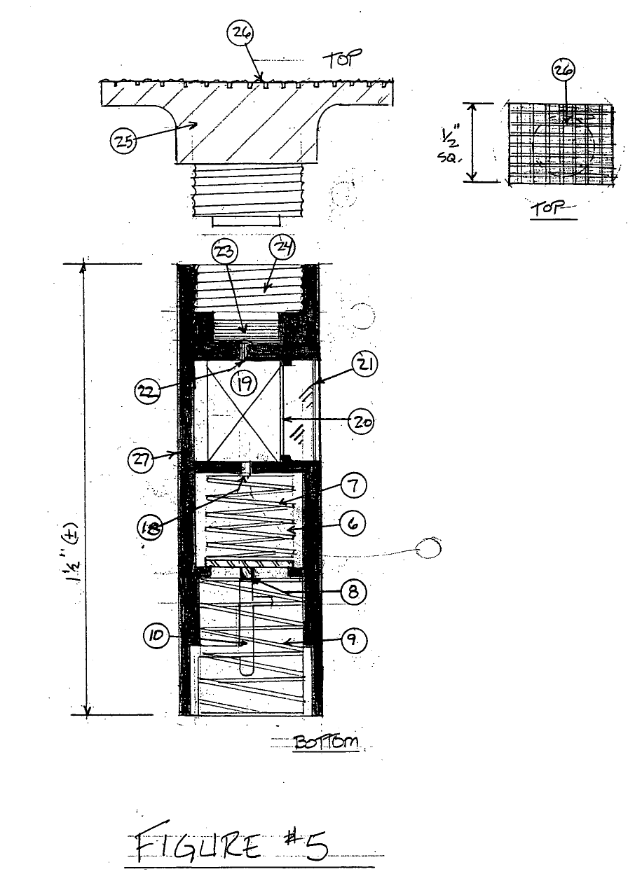

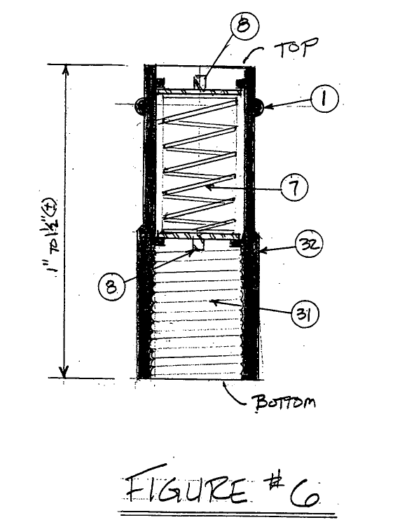

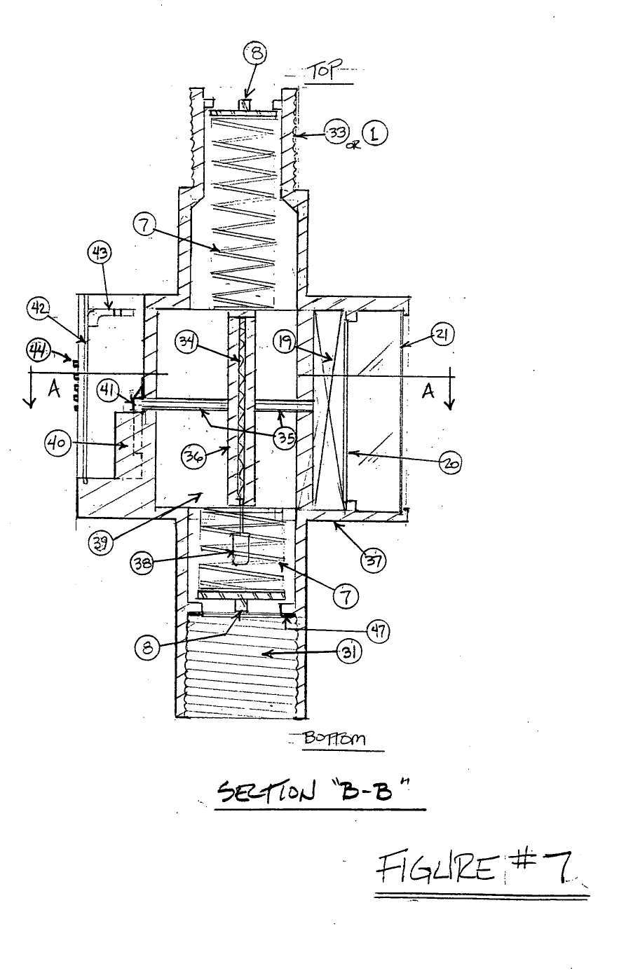

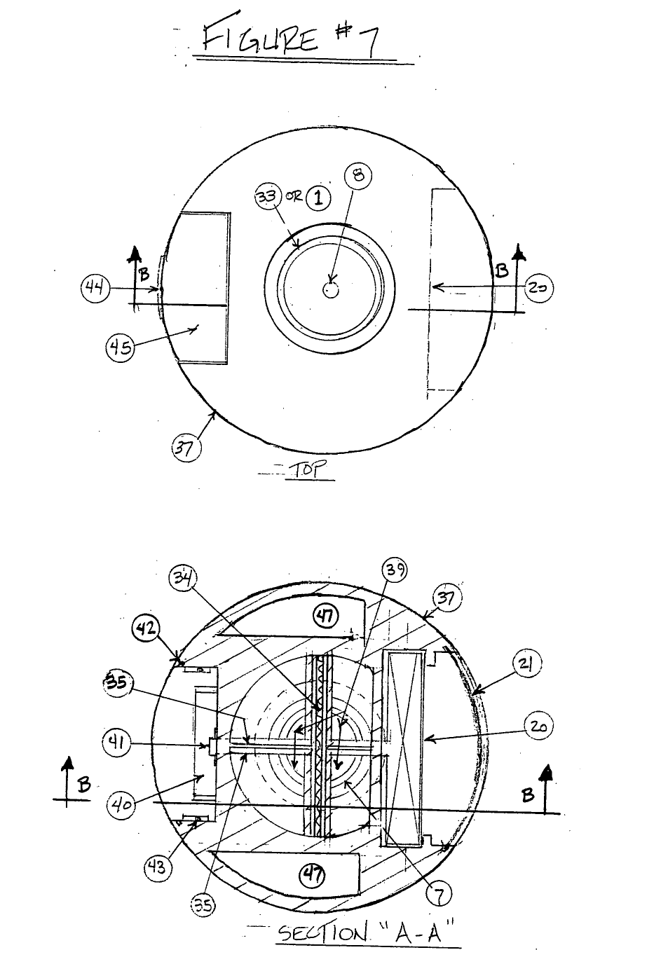

1.) FIG. #7 is a tire gage radio transmitted signal monitoring device that will fit on existing design valve stems and is able to stay on the valve stem at all times even while feeding air into FIG. 7, and into tire but can be removable as needed.

2.) FIG. #1 through # 3 are manual tire pressure gage devices that monitor the air pressure in your tire by pushing the figures down an internal gage stick pops out which tells you if your pressure is ok and is capable of fitting any existing valve stems.

3.) FIG. #5 is a manual tire pressure gage with a digital display screen that will work with FIG.#4 threaded valve stem adaptor which will screw onto existing valve stems to receive FIG.#1 and #5 and be monitored from outside the vehicle only.
